(19) United States
(12) Patent Application Publication
(10) Pub. No.: US 2007/0044626 A1
(43) Pub. Date: Mar. 1, 2007

(54) Overmolded food product table support arm for a food slicer

(76) Inventors: Frank A. Bondarowicz, St. Glenview, IL (US); Scott J. Rote, New Lenox, IL (US); Scott M. Zeeb, Chicago, IL (US); Aaron B. Eiger, Chicago, IL (US)

Correspondence Address: Mark W. Croll;Illinois Tool Works Inc., 3600 West Lake Avenue, Glenview, IL, 60026, US

(21) Appl. No.: 11/348,564

(22) Filed: Feb. 7, 2006

Related U.S. Application Data
(60) Provisional application No. 60/711,835, filed on Aug. 26, 2005.

(51) Int. Cl. B26D 1/143

(52) U.S. Cl. 83/717; 83/932

(57) ABSTRACT

A food slicer is provided having a support member including a base portion and an upstanding portion integrally formed with the base portion. The upstanding portion includes a rotating cutting blade secured thereto for slicing food product and at least one motor positioned within the upstanding portion for rotating the cutting blade. The base portion includes a food product table slidably secured thereto and is movable across the cutting blade for holding product while it is being sliced by the cutting blade. An adjustable gage plate also is provided for determining the thickness of a food product to be sliced by the cutting blade. A support arm for said food product table is provided for supporting the food product table as it moves across the cutting blade, the support arm being a two piece construction formed by an overmold injection molding process with no seams below the product table exposed to food scraps or juices.

### CROSS-REFERENCE TO RELATED APPLICATIONS

This application claims benefit of U.S. provisional patent application Ser. No. 60/711,835, filed Aug. 26, 2005, which is herein incorporated by reference.

### TECHNICAL FIELD

The present invention relates generally to food slicers and more particularly to a new design for the support arm for the food product table of a food slicer that provides for an enhanced sanitary environment, enables easier operation and cleaning and incorporates a number of enhanced ergonomic features.

### BACKGROUND

The basic design of both manual and automatic food slicers has proven to be quite effective and durable throughout the years. Although various important improvements have been made to such slicers, the overall design has not changed very much particularly with regard to the overall cleanliness, ergonomics, or ease of operation.

Today, food slicers are utilized to slice a number of food products such as meats, cheeses and the like in a variety of environments such as delicatessens, supermarkets, and restaurants to name a few. Such food slicers need to be quite durable since they tend to be used for many hours during a day by many different individuals while providing the desired performance, safety and cleanliness.

Additionally, food slicers need to be designed to allow adaptability since they need to handle a variety of products of different shapes, sizes, and textures while readily providing slices of different thicknesses of the product being sliced. The speed at which a particular product is moved across the cutting blade can also vary on automatic food slicers to improve productivity.

Gravity food slicers typically included a reciprocating food product table that is supported by a slicer arm or support arm. The support arm is connected on its end opposite the food product table to the particular driving mechanism of the food slicer that provides the desired reciprocating movement of the food product table.

Due to the complex geometry needed for such support arms, they typically are constructed in two or more pieces. Thus, when assembled, existing support arms provide a seam, crevice or the like within which food scraps, juices and debris can accumulate.

### SUMMARY

In accordance with an embodiment, a food slicer is provided having a support member including a base portion and an upstanding portion integrally formed with the base portion. The upstanding portion includes a rotating cutting blade secured thereto for slicing food product and at least one motor positioned within the upstanding portion for rotating the cutting blade.

The base portion includes a food product table slidably secured thereto and is movable across the cutting blade for holding product while it is being sliced by the cutting blade. An adjustable gage plate also is provided for determining the thickness of a food product to be sliced by the cutting blade.

A support arm for the food product table is provided for supporting the food product table as it moves across the cutting blade, the support arm being a two piece construction formed by an overmold injection molding process with no seams below the product table exposed to food scraps or juices.

### BRIEF DESCRIPTION OF THE DRAWINGS

The present disclosure will become better understood with reference to the following description and accompanying drawings, wherein:

FIG. 1 is a top right perspective view of a food slicer according to one embodiment of the present invention;

FIG. 2 is a front plan view of the food slicer of FIG. 1;

FIG. 3 is an exploded perspective view of a food product table support arm of the food slicer of FIGS. 1 and 2;

FIG. 4 is a longitudinal cross-sectional view of the assembled food product table support arm of FIG. 3;

FIG. 5 is a lateral cross-sectional view of the assembled food product table support arm taken generally along the line 5-5 of FIG. 4; and

FIG. 6 is a front plan view of the assembled food product table support arm of FIGS. 3 and 4.

### DETAILED DESCRIPTION

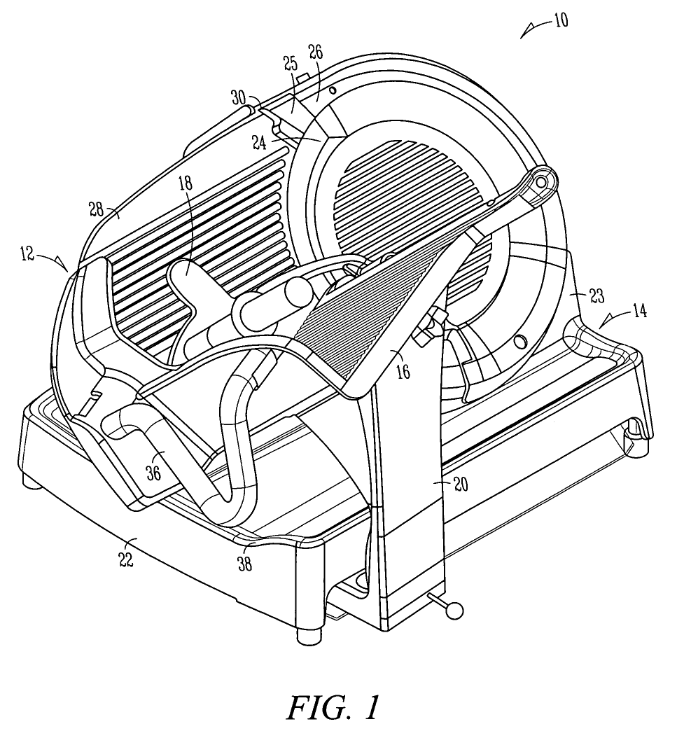

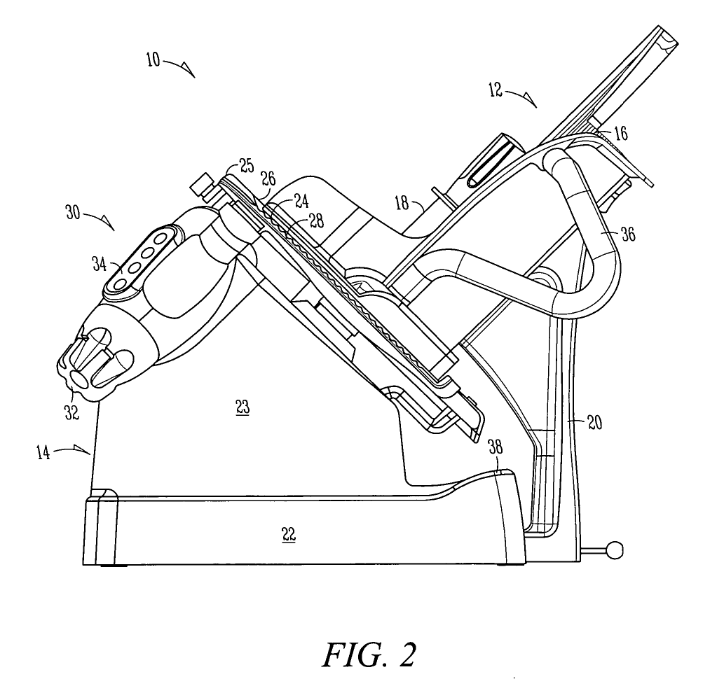

The food slicer of the present invention is generally illustrated by numeral 10 of FIGS. 1-2 wherein like parts are designated by like reference numerals. Although the present disclosure will be described with reference to the example embodiments illustrated in the figures, it should be understood that the food slicer 10 may have many alternative forms without departing from the teachings of the present invention. One of ordinary skill in the art will additionally appreciate different ways to alter the parameters of the embodiments disclosed, such as the size, shape, or type of elements or materials, in a manner that falls within the spirit and scope of the present disclosure and appended claims.

FIGS. 1 and 2 illustrate the basic components of the food slicer 10 of the present invention. The food slicer 10 substantially includes a food handling portion generally illustrated by reference numeral 12 and a support portion, housing or member generally illustrated by reference numeral 14.

The food handling portion 12 substantially includes a product table 16, a push arm or pusher 18 and a product table support arm 20. The support portion 14 substantially includes a base portion or member 22, an upstanding portion or member 23, a rotating circular slicing knife or cutting blade 24, a ring guard 25, a knife cover 26, an adjustable gage plate 28 for determining slicing thickness and a control member or operator interface 30 having a gage plate support and adjustment mechanism 32 for the gage plate 28 and control buttons 34 as illustrated in FIG. 2.

The support portion 14 also includes at least one motor (not illustrated) positioned within the inside of the upstanding portion 23. If desired, a second motor (not illustrated) may be positioned within the inside of the support portion 14 along with associated structure for automatically moving the product table 16.

Briefly, for manual slicing, a food product (not illustrated) is placed on the product table 16 beneath the pusher 18 with the end to be cut or sliced resting upon the gage plate 28 with the product table 16 in its forward position. The operator adjusts the gage plate adjustment mechanism 32 which directly moves the gage plate 28 with respect to the blade 24 to provide a slice thickness gap therebetween that corresponds to the desired thickness for slicing of the product and gets bigger with thicker slices. The control buttons 34 are then accessed to turn the motor on which in turn rotates the blade 24.

The operator then pushes the product table 16 preferably via a handle 36 or other contact point forward or to the right with respect to FIG. 1 whereby the blade 24 slices the product to the desired thickness. The operator then pulls the product table 16 backward or to the left with respect to FIG. 1 for continued slicing of the product as described above.

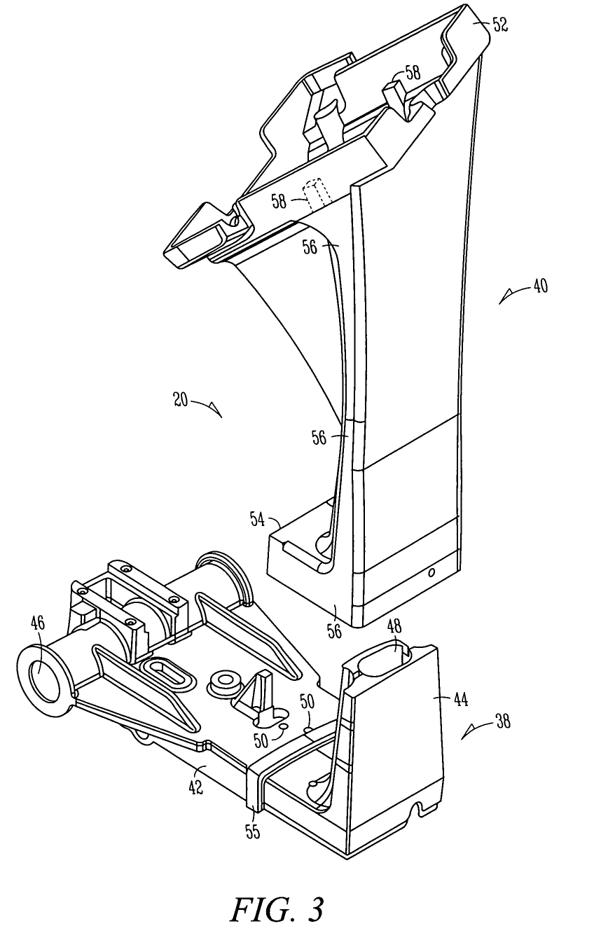

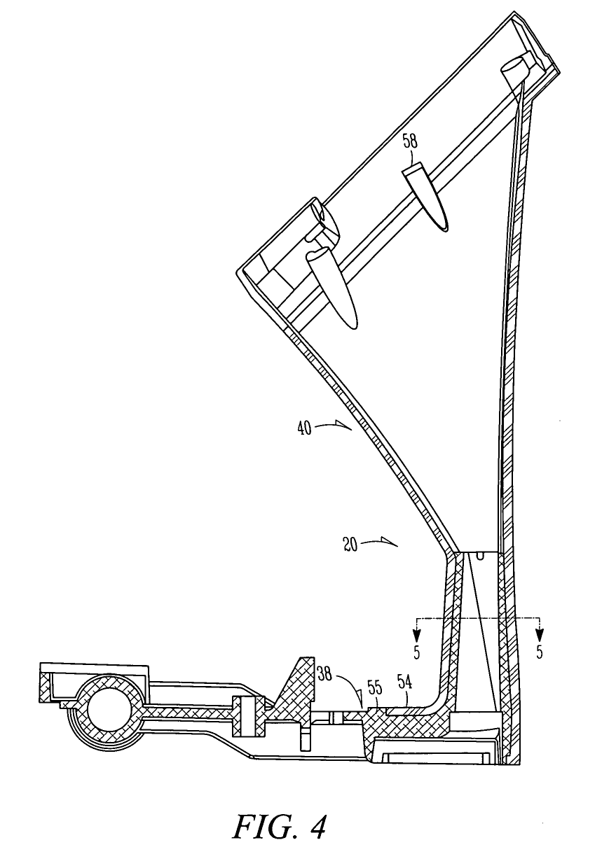

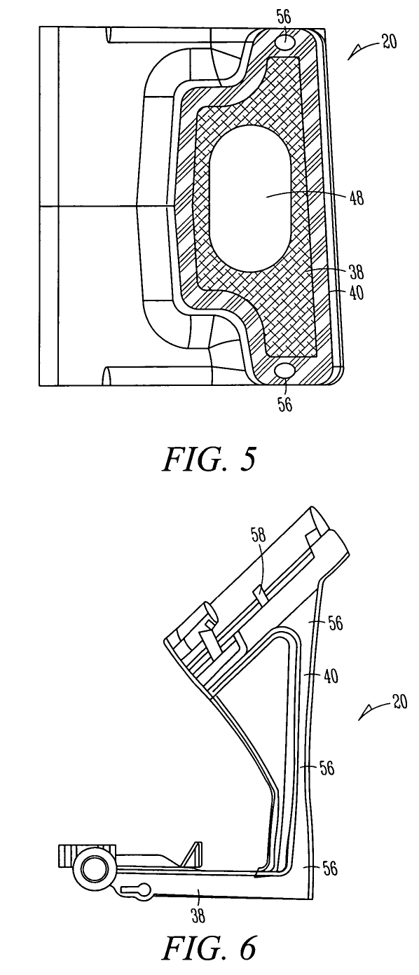

As FIGS. 3-6 generally illustrate, the support arm 20 for the food product table 16 includes a first bottom portion 38 and a second top portion 40 which is overmolded onto the first bottom portion 38 as described below. When molded together and assembled to the food slicer 10, the support arm 20 is uniquely designed to reduce contamination by being free of unnecessary exposed seams, nooks and crannies, joints, seals, plugs apertures or the like and other places where food scraps and juices may get caught beneath the product table 16.

As FIG. 3 illustrates, the first bottom portion 38 is generally “L” shaped and includes a first leg portion 42 and a second leg portion 44 integrally formed with the first leg portion 42. In one preferred embodiment, the first bottom portion 38 preferably is made from aluminum by permanent mold casting with one sand core and one solid core, but can be made from any desired material in any desired manner.

To provide the desired transport motion for the product table 16, the first leg portion 42 includes a channel 46 formed at is distal end opposite the second leg portion 44. The channel 46 accepts a guide rod (not illustrated) secured beneath the slicer 10 running from the front of the slicer 10 to the back of the slicer 10. The support arm 20 can slide along the guide rod to provide the desired reciprocating movement of the product table 16 across the blade 24 to slice the product. One or more bushings (not illustrated) can be included to assist with the sliding engagement between the support arm 20 and the guide rod.

To provide further support to the support arm 20, a roller (not illustrated) can be provided that rides in a rail (not illustrated) secured to the underside of the base portion 22 of the support portion 14. It is to be understood, however, that the particular mounting of the support arm 20 to the slicer 10 can vary.

The second leg 44 includes a hollow channel 48 through which a control or other cable (not illustrated) can extend, such as for an interlock for mounting of the food product table 16, for example. To enable injection molding of the second top portion 40 onto and around portions of the first bottom portion 38, one or more apertures (not illustrated) can be positioned in the first leg 42 or second leg 44. It is to be understood that the particular shape, size, features, materials and dimensions of both the first bottom portion 38 and second top portion 40 can vary.

Briefly, to overmold the second top portion 40 onto the first bottom portion 38, the first bottom portion 38 is inserted into the mold or tool. The mold is then closed and the desired material, preferably plastic, is injected through the apertures in the second bottom portion 38 and the plastic works its way into the various holes, grooves etc. about the second bottom portion 38 and fills the remaining areas of the mold. As described in more detail below, gas is also injected during molding to provide desired channels that help to strengthen the second top portion 40. Once the plastic solidifies, the mold is opened and the completed support arm 20 is removed with the second top portion 40 integrally overmolded onto the first bottom portion 38.

The second top portion 40 is substantially hollow and includes a first end 52 designed to accept a top cover having an interlock mechanism (not illustrated) for the product table 16 and a second opposite end 54 for overmolding onto the second leg 44 of the first bottom portion 38 and abuts against a shoulder 55 formed in the first bottom portion 38. The second top portion 40 preferably is formed from a food contact grade of glass reinforced nylon, but can vary.

The top cover removably secures the product table 16 to the support arm 20 and accepts the control or interlock cable that extends through the channel 48 and the second top portion 40 and prevents the product table 16 from being removed, such as for cleaning, unless it is in a desired fully forward or “home” position that is to the left with respect to FIG. 1. An additional control mechanism (not illustrated) also is provided to prevent the product table 16 from being removed unless the gage plate 28 also is in its fully closed position. Also, once the product table 16 is secured to the support arm 20, the product table 16 effectively shields the first end 52 of the second top portion 40 from food scraps and juices.

During molding, the second end 54 of the second top portion 40 substantially adheres to the shoulder 55. Thus, although a small line may be formed therebetween, there is no seam within which food scraps and juices can accumulate. Additionally, since this seam is beneath the base portion 22 of the food slicer 10 when assembled, the base portion 22 effectively shields this interface.

As FIGS. 3, 5 and 6 generally illustrate, to provide enhanced rigidity the second top portion 40 of the support arm 20 is reinforced along its length by providing a hollow section generally illustrated with the reference numeral 56. The reinforcements 56 preferably are hollow channels, one each formed on the left and right side of the top portion 40 as viewed in FIG. 3. The channels 56 extend longitudinally through the length of each side of the top portion 40. They generally mirror the cross-sectional size of the respective side portions and thus in one preferred embodiment have the general shape of an hour glass. The channels 56 preferably are closed at their ends.

The hollow channels 56 preferably are integrally formed with the second top portion 40 of the support arm 20 during molding of the second top portion 40 over the first bottom portion 38. To form the hollow channels, a gas-assist injection molding process preferably is used where a gas, typically nitrogen, is injected through gas ports 58 (see FIG. 3) into the material during molding at desired locations at a specific temperature and pressure at a desired point in time during the molding process. One gas port 58 is illustrated on the right side of the second top portion 40 and another gas port 58 is illustrated in dotted lines on the left side of the second top portion 40. It is to be understood that the size, placement and number of gas ports 58 can vary.

The second top portion 40 of the support arm 20 preferably is formed from plastic to decrease weight since it is a moving component of the slicer 10. To further enhance its rigidity, the second top portion 40 can be formed to include additional strengthening members, such as solid ribs or channels, or a strengthening material or additive, such as glass or the like. In practice, using 30% glass filled nylon provides the desired rigidity. It is to be understood, however, that the specific design, material shape and method of molding the second top portion 40 including the reinforcements 56, hollow channels, as well as the type and amount of any strengthening additive or strengthening member can vary.

Numerous modifications and alternative embodiments of the present disclosure will be apparent to those skilled in the art in view of the foregoing description. Accordingly, this description is to be construed as illustrative only and is for the purpose of teaching those skilled in the art the best mode for carrying out the present disclosure. Details of the structure may vary substantially without departing from the spirit of the present disclosure, and exclusive use of all modifications that come within the scope of the appended claims is reserved. It is intended that the present disclosure be limited only to the extent required by the appended claims and the applicable rules of law.

What is claimed is:

1. A food slicer, comprising:
a support member having a base portion and an upstanding portion integrally formed with said base portion;
a rotating cutting blade secured to said upstanding portion for slicing food product;
at least one motor positioned within said upstanding portion for rotating said cutting blade;
a food product table movably secured to said base portion and movable across said cutting blade for holding product while being sliced by said cutting blade;
an adjustable gage plate for determining the thickness of a food product to be sliced by said cutting blade; and
a support arm for said food product table for supporting said food product table as it moves across said cutting blade, said support arm being a two piece construction formed by an overmold injection molding process with no seams below the food product table exposed to food scraps or juices.

2. The food slicer as defined in claim 1, wherein said support arm includes a first end secured to a bottom surface of said food product table and a second end secured beneath said base portion of said support member.

3. The food slicer as defined in claim 2, wherein said second end is secured beneath said base portion for manual movement by an operator.

4. The food slicer as defined in claim 2, wherein said second end is operably secured beneath said base portion for automatic movement by a second motor.

5. The food slicer as defined in claim 1, wherein said two pieces are of different materials.

6. The food slicer as defined in claim 5, wherein one piece is formed from plastic which is overmolded onto a second piece formed from aluminum.

7. The food slicer as defined in claim 1, wherein said support arm includes at least one reinforcement having a hollow channel therein.

8. A support arm for a food product table for a food slicer, comprising:
a first portion in operable communication with a transport mechanism of the food slicer; and
a second portion for connection to the food product table, said second portion being overmolded onto said first portion in an injection molding process with no seams exposed to food scraps and juices.

9. The support arm as defined in claim 8, wherein said transport mechanism provides for manual movement of said support arm by an operator.

10. The support arm as defined in claim 8, wherein transport mechanism provides for automatic movement of said support arm by a second motor.

11. The support arm as defined in claim 8, wherein first and second portions are of different materials.

12. The support arm as defined in claim 11, wherein said second portion is formed from plastic which is overmolded onto said first portion that is formed from aluminum.

13. The support arm as defined in claim 8, wherein said second portion includes at least one reinforcement having a hollow channel therein.
